(19) United States
(12) Patent Application Publication
(10) Pub. No.: US 2020/0367449 A1
(43) Pub. Date: Nov. 26, 2020

(54) WATER VAPOR SUPPRESSION MATERIAL AND PRODUCTION METHOD THEREFOR

(71) Applicant: Teshima Tusho Corporation, Kochi (JP)

(72) Inventor: Hiromitsu Teshima, Kochi (JP)

(21) Appl. No.: 16/637,182

(22) PCT Filed: Aug. 7, 2018
(86) PCT No.: PCT/JP2018/029632

§ 371 Date: Feb. 6, 2020

(30) Foreign Application Priority Data
Aug. 7, 2017 (JP) 2017-152534

(51) Int. Cl. A01G 15/00; B01J 2/28

(52) U.S. Cl. CPC A01G 15/00; B01J 2/28

(57) ABSTRACT

A water vapor suppression material may include grains obtained by (1) granulating a natural glue of plant origin, for being distributed over a water surface to suppress the evaporation of water vapor, or (2) forming a mixture of a natural glue of plant origin and a plant-based powder into a granular shape, for being distributed over a water surface to suppress the evaporation of water vapor.

### CROSS-REFERENCE TO RELATED APPLICATIONS

This application claims priority to International Patent Application Number PCT/JP2018/029632, filed on Aug. 7, 2018, and Japanese Patent Application Number 2017-152534, filed on Aug. 7, 2017, the contents of both of which are hereby incorporated by reference in their entirety.

### TECHNICAL FIELD

The present invention suppresses excessive water vapor generation from a water surface, which is the main cause of meteorological disasters frequently occurring in recent years, and relates to a water vapor suppression material for covering an ocean water surface in a specific ocean area on the tropical ocean around the equator, for example, thereby suppressing excessive water vapor generation and alleviating the occurrence of meteorological disasters in the coastal area, and also to a production method therefor.

### BACKGROUND

In recent years, on the tropical ocean around the equator, for example, the temperature of the ocean water surface has been increasing, causing excessive evaporation of water vapor. Thus, the saturated water vapor reaches a supersaturated state before widely diffusing into the atmospheric air, resulting in the occurrence of a large number of tropical cyclones.

For this reason, normal circulation of water vapor in the atmospheric air is inhibited, leading to damages to the coastal area due to tornados, typhoons, torrential rain or snow, or abnormal drought with increased frequency and increased intensity.

As means to deal with these meteorological disasters, shore protection development and development of drainage canals, snow removal and snow melting, development of dams and planned water restrictions as measures against water shortage, and the like have been made using weather forecasts. However, a solution to the fundamental cause has not been reached.

Thus, as an invention to be floated on the lake or ocean to cover the surface, thereby preventing the evaporation of moisture, the floating body for covering a water surface disclosed in JP 2003-125695 A (Patent Literature 1) is known.

The floating body includes a flat bag body obtained by processing a laminate, which is obtained by laminating a woven fabric, a knitted fabric, or a nonwoven fabric with a flexible synthetic resin layer, into a bag shape, and, inside the flat bag body, a large number of cells made of a synthetic resin obtained by enclosing air or the like to obtain buoyancy are provided. The floating body covers a water surface to prevent the generation of plankton, such as Microcystis.

In addition, the floating body is also aimed at covering a water surface and blocking sunlight and air, thereby preventing the evaporation of moisture from the lake or the like. However, it is necessary to connect a large number of floating bodies one by one to expand the area, and also, because the material is not biodegradable, considering adverse effects on the environment, recovery is necessary after use. Further, also in terms of strength, production, and transportation, even if application to a certain narrow range, such as a lake, is possible, application over a large area, such as on the ocean, will be realistically impossible.

Further, as an invention made for preventing the evaporation of moisture from an ocean water surface to prevent a typhoon, the typhoon prevention device disclosed in Japanese Patent No. 2727128 (Patent Literature 2) is known.

According to this device, a cover made of a vinyl chloride resin or the like that has been surface-treated to reflect sunlight is spread to cover an ocean water surface between floating bodies on the ocean surface moored with anchors on the bottom of the ocean in such a manner to be spaced apart from the land without mooring on the land, thereby preventing the evaporation of water vapor from the ocean water surface so as to prevent the occurrence of a typhoon.

However, because the device is a sheet-shaped cover for covering an ocean water surface, considering the tension due to the self-weight or the influence of wind or wave on the ocean, upsizing is limited in terms of strength, and, also in terms of transportation and the covering operation, the device is unsuitable for upsizing. Thus, it is difficult to cover a large water surface area of the ocean. Therefore, it is likely that the effect of preventing the evaporation of water vapor from an ocean water surface is extremely limited.

In addition, because sunlight is reflected by the sheet surface, the covered part completely blocks sunlight. Accordingly, even of an opening for ventilation is provided, the environmental consciousness is not sufficient, and the sheet is particularly unsuitable for upsizing. Further, a material that is not biodegradable is likely to have significant adverse effects on the environment in the ocean.

Like this, when the conventional device for preventing water vapor generation from a water surface is to be upsized to cover a large area of the ocean, there are problems with strength, transportation, operation, and the like, and it is difficult to prevent the evaporation of water vapor over a wide range. In addition, because of its constituent materials, water vapor generation suppression method, and the like, adverse effects on the marine environment are of concern.

### CITATION LIST

### Patent Literature

Patent Literature 1: JP 2003-125695 A
Patent Literature 2: Japanese Patent No. 2727128

### SUMMARY

The present invention solves the problems of prior art described above, and an object thereof in to provide a water vapor suppression material that is capable of easily covering not only a water surface of lake size but also a large water surface area on the ocean, thereby suppressing excessive generation of water vapor, which is the fundamental cause of meteorological disasters, and is also biodegraded or dissolved/diffused into water, and thus returned to the environment, whereby environmental burdens can be reduced; and also a method for producing the water vapor suppression material.

According to a water vapor suppression material including grains obtained by granulating a natural glue of plant origin, for being distributed over a water surface to suppress the evaporation of water vapor, the evaporation of water vapor from a water surface is suppressed, and, in addition, because the raw material is plant-derived and thus eventually returned to the natural environment, environmental burdens are reduced.

Further, according to a water vapor suppression material including grains obtained by forming a mixture of a natural glue of plant origin and a plant-based powder into a granular shape, for being distributed over a water surface to suppresses the evaporation of water vapor, the evaporation of water vapor from a water surface is suppressed, and, in addition, because the raw materials are all plant-derived and thus eventually returned to the natural environment, environmental burdens are reduced.

Here, according to the water vapor suppression material described above, wherein the plant is seaweed or algae, as compared to prior art, the water vapor suppressing effect by the covering of an ocean water surface is obtained more, while burdens on the marine environment can be reduced.

In addition, according to the water vapor suppression material described above, wherein the grains have enclosed therein air bubbles, the increase rate of the surface area is suppressed relative to the increase rate of the volume, and, in addition, higher buoyancy occurs. As a result, the water vapor suppressing effect by the covering of a water surface can be obtained for a longer period of time.

Further, according to the water vapor suppression material described above, wherein the grains are surface-coated with a natural glue of plant origin that serves as a coating agent, the period until complete dissolution into water can be extended, and the water vapor generation suppressing effect by the covering of a water surface can be obtained for a longer period of time.

In addition, according to the water vapor suppression material described above, wherein the water surface over which the material is distributed is an ocean water surface, and excessive evaporation of water vapor from the ocean water surface is suppressed, as compared to prior art, a larger area can be covered, and thus the reducing effect on the occurrence of meteorological disasters by the water vapor suppressing effect can be obtained more.

Of the water vapor suppression materials described above, one wherein the plant is seaweed or algae can be obtained by a method for producing a water vapor suppression material, characterized in that algae or seaweed is dried, formed into a powder shape, then re-dried, mixed with a natural glue of plant origin that serves as a binder, kneaded to such a viscosity that air bubbles can be contained, and formed into a belt shape; several layers of the belt-shaped mixture are stacked while enclosing air bubbles, granulated into a granular shape, and then dried; and the granules are surface-coated with a natural glue of plant origin that serves as a coating agent and then dried.

According to the water vapor suppression material of the present invention, the position and range of the water surface where the evaporation of water vapor is suppressed, timing, and the like can be easily adjusted, and not only a water surface in a narrow range, such as a pond or a lake, but also a water surface over a wider range than prior art can be covered, whereby a greater water vapor generation suppressing effect can be obtained. However, unlike the conventional material that is sheet-shaped and completely blocks sunlight/air, sunlight/air moderately reaches inside the ocean, and thus the influence on living things in the ocean is small. In addition, because the material is harmlessly returned to the environment as a result of biodegradation or dissolution/diffusion into water, environmental burdens can be reduced.

Further, because a dried powder of seaweed or algae is mixed with a natural glue of plant origin, seaweed or algae living in the ocean or stranded on the beach, for example, can be used effectively. At the same time, while floating on the ocean surface and covering the ocean surface, even when the floating water vapor generation suppression material and the water vapor suppression material dissolved/diffused into the ocean are incorporated by living things in the ocean, such as microorganisms and fishes, there is no adverse effect.

In addition, the water vapor suppression material of the present invention is in the form of grains or grains having granular shapes. Accordingly, unlike the conventional sheet, a large-scale structure or the operation of spreading on the ocean is not required, and, for example, the material can be distributed over a large range at once from an airplane. Thus, when a specific ocean area on the tropical ocean around the equator where excessive water vapor generation is occurring, which causes a meteorological disaster, is covered intensively for a fixed period, it does not happen that water vapor evaporated from the ocean into the atmospheric air reaches a supersaturated state, excessively causing a tropical cyclone. Rather, under an anticyclone, water vapor moderately diffuses to a high altitude over a large area, whereby the occurrence of meteorological disasters in the coastal area can be alleviated and suppressed. In addition, a method for producing a water vapor suppression material that is more suitable to obtain such an effect in the ocean can be provided.

### BRIEF DESCRIPTION OF THE DRAWINGS

FIG. 1 is a schematic enlarged cross-sectional view showing preferred embodiments of the present invention; (a) is a cross-sectional view of a water vapor suppression material in the form of a rectangular parallelepiped, and (b) is a cross-sectional view of a water vapor suppression material in the form of an ellipsoid.

FIG. 2 is a schematic diagram showing an example of the distribution of the water vapor suppression material of the present invention over a water surface.

FIG. 3 is a cross-sectional schematic diagram showing how the distributed water vapor suppression material dissolves while covering the water surface; (a) is a cross-sectional view at the time when a water vapor suppression material in the form of a rectangular parallelepiped or an ellipsoid starts covering the water surface, (b) is a cross-sectional view at the time when the water vapor suppression material starts dissolving, (c) is a cross-sectional view at the time when most of the natural glue of plant origin that coats the surface of the water vapor suppression material has dissolved, and (d) shows the water vapor suppression material that has dissolved to such a degree that its shape is hardly retained.

FIG. 4 is a schematic diagram showing a preferred embodiment of the method for producing a water vapor suppression material of the present invention; (a) is a schematic diagram showing seaweed or algae, which is a raw material for a powder, living in the ocean, (b) is a schematic diagram showing the seaweed or algae that has been dried, (c) is a schematic diagram showing the dried seaweed or algae that has processed into a powder shape, (d) is a schematic diagram showing the dry seaweed or algae powder that has been mixed with a natural glue of plant origin, (e) is a cross-sectional view showing the mixture that has been formed into a belt shape and stacked in layers, (f) is a cross-sectional view of granules at the time when the mixture stacked in layers has been granulated and formed into a granular shape, (g) is a cross-sectional view at the time when the granules have been dried, and (h) is a cross-sectional view of a water vapor suppression material obtained by surface-coating the dried granules with a natural glue of plant origin, followed by drying.

FIG. 5 is a schematic diagram showing specific ocean areas where the present invention is to be distributed.

### DETAILED DESCRIPTION

Hereinafter, preferred embodiments of the present invention will be described in detail with reference to the drawings.

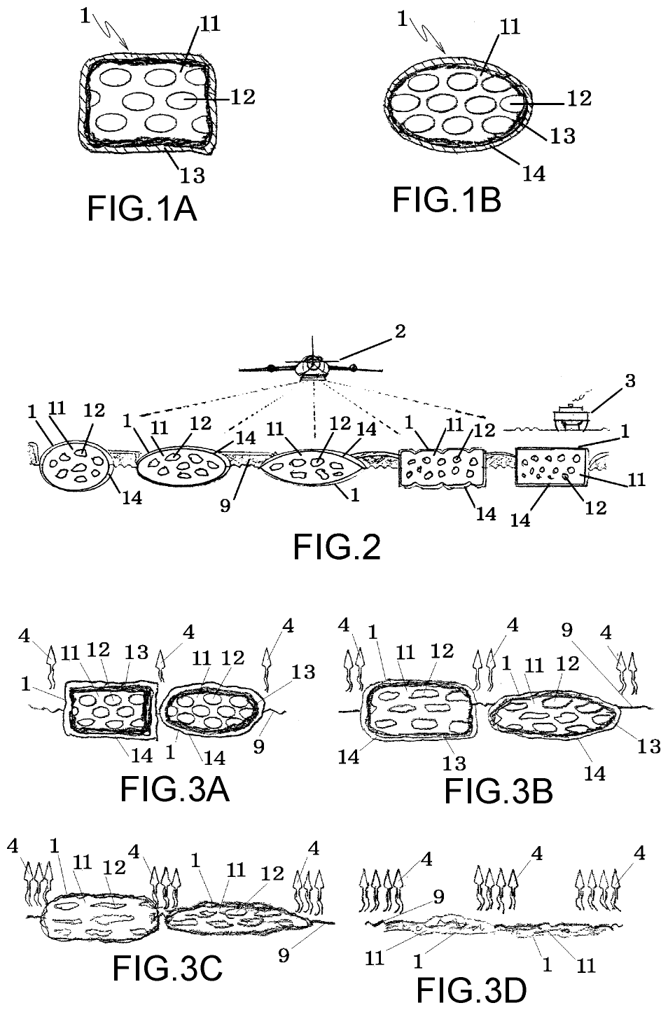

FIG. 1 is a cross-sectional enlarged schematic diagram showing preferred embodiments of the water vapor suppression material 1 of the present invention. The water vapor suppression material 1 is obtained as follows. For example, a mixture 11 of a plant-based powder, such as seaweed or algae, with a starch-based natural glue of plant origin, such as rice, is caused to enclose air bubbles 12 and formed into a granular shape, followed by drying, and the periphery of the surface 13 is coated with a coating agent 14 composed a natural glue of plant origin.

According to this embodiment, seaweed or algae is used as a plant powder to achieve its effective use, and such a material is suitable for use in the ocean or the like, but other plants may also be used. In addition, as a natural glue of plant origin, in terms of viscosity, one using a starch, such as rice, as a raw material, where air bubbles can be easily enclosed, is suitable, but other natural glues of plant origin are also possible. The amount of coating agent is adjusted according to the desired floating/dissolution time.

Then, because the water vapor suppression material 1 of the present invention has a granular shape, by distributing such a material over a water surface, the water surface can be covered over a large range, and a water vapor suppressing effect can be obtained over a large range. At this time, the covered range can also be adjusted by increasing or decreasing the distribution amount. Further, because the raw materials are all plant-derived and dried, and air bubbles are enclosed therein, the specific gravity is less than water, and the material can float on the water surface. During floating, the layer of the natural glue of plant origin 14 on the surface, which is a coating agent, gradually dissolves, and then the mixture 11 of a plant powder and a natural glue of plant origin, which are raw materials, gradually dissolve. During this time, the water surface 9 having distributed thereon the material is continuously covered, and the evaporation of water vapor 4 from the water surface can be suppressed.

More specifically, according to this embodiment, as shown in FIG. 1, the water vapor suppression material 1 is a rectangular parallelepiped (a) or an ellipsoid (b), and each formed to be longer in the direction parallel to the water surface over which the material is distributed than in the perpendicular direction. Thus, as compared to a sphere or the like, for example, the covered area of the water surface and the resulting buoyancy can be increased.

FIG. 2 is a schematic diagram showing a preferred embodiment in the case of distributing the water vapor suppression material 1 of the present invention over a water surface. From the air using an airplane 2 while flying, or from the water surface form a sailing special ship 3 for the collection of raw material plants, processing into a water vapor suppression material, and distribution, the water vapor suppression material is distributed over a water surface while maintaining a moderate density, whereby the water surface 9 can be covered, and the evaporation of water vapor can be suppressed. At this time, the position and range to be covered are adjusted by changing the sailing route, the distribution amount, and the like.

FIG. 3 shows how the water vapor suppression material 1 distributed over a water surface in the above embodiment covers the water surface and dissolves while suppressing the evaporation of water vapor 4.

According to this embodiment, the water surface 9 is covered with the water vapor suppression material 1 in the form of a rectangular parallelepiped or an ellipsoid. As a result, unlike a conventional material that is sheet-shaped and completely blocks sunlight/air, while suppressing excessive evaporation of water vapor, moderate evaporation is allowed. As a result, while preventing frequent occurrence of tropical cyclones, moderate diffusion of water vapor is brought about.

Further, according to this embodiment, while covering the water surface 9, the water vapor suppression material 1 in the form of a rectangular parallelepiped or an ellipsoid dissolves as described above. Accordingly, the space between the water vapor suppression materials 1 gradually opens, and the evaporation of water vapor increases. Therefore, in some cases, it is also possible to additionally distribute the water vapor suppression material 1 to adjust the amount of water vapor suppression. Then, the water vapor suppression material 1 is entirely plant-based. Therefore, as a result of diffusion into water or incorporation into underwater living things, the material is returned to the environment. Thus, there is no adverse effect on the environment, and no special recovery operations are necessary.

Incidentally, according to this embodiment, a mixture obtained by mixing a plant-based powder with a natural glue of plant origin is used. Thus, effectively using plants such as seaweed, large-scale production is easy. However, it is also possible that a plant-based powder is not mixed, and grains are formed only from a natural glue of plant origin. In addition, depending on the intended use, coating is also unnecessary.

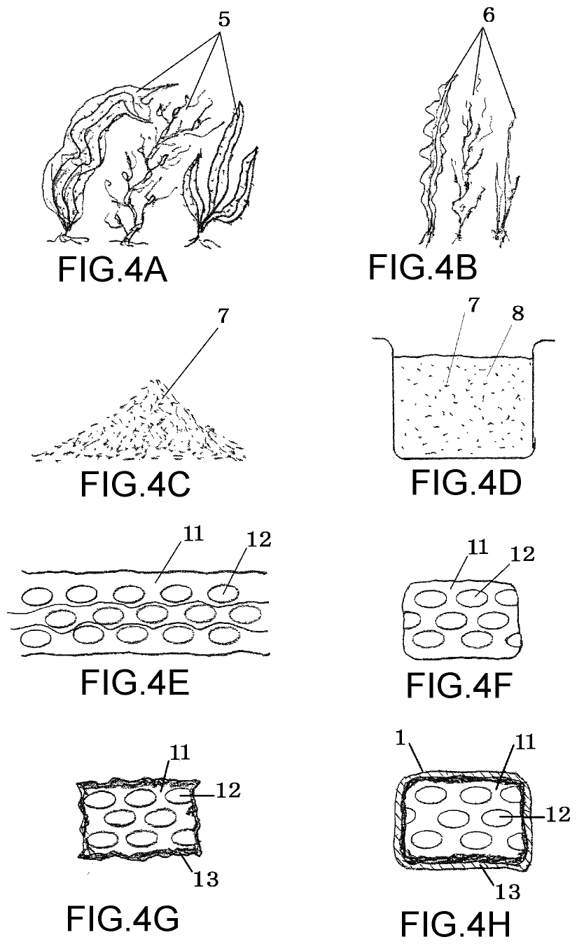

FIG. 4 shows a preferred embodiment of the production method of the present invention. Seaweed or algae, such as green algae, brown algae, or red algae, (hereinafter referred to as “seaweed or the like”) 5 is dried into dried seaweed or the like 6. The seaweed or the like 6 is cut into a powder shape and then further dried into a powder 7 of the seaweed or the like. The powder 7 is mixed with a natural glue of plant origin 8, which is a rice- or like starch-based binder, and kneaded to such a viscosity that air bubbles 12 can be sufficiently contained, thereby giving a mixture 11. The mixture 11 is formed into a belt shape. Layers of the belt-shaped mixture are stacked so as to enclose air as shown in the cross-sectional view (e), the belt-shaped mixture in layers is granulated into wet granules as shown in the cross-sectional view (f), the wet granules are dried into dry granules as shown in the cross-sectional view (g), and the surface is coated with a natural glue of plant origin 8 as shown in the cross-sectional view (h), followed by drying, thereby giving a water vapor suppression material 1 using the seaweed or the like as a raw material.

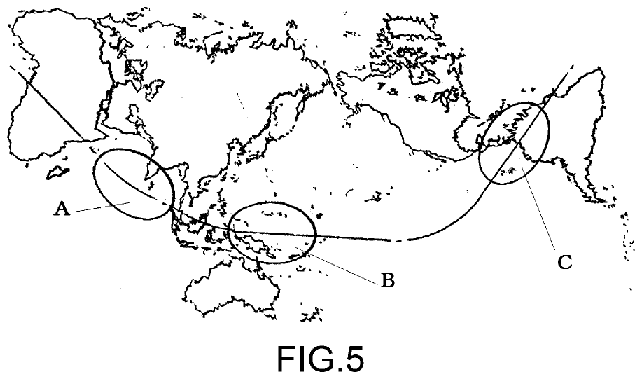

FIG. 5 shows preferred ocean areas where the water vapor suppression material 1 of the present invention is distributed. By distributing the material in the area of tropical cyclone formation in the Indian Ocean (A), the area of tropical cyclone formation in the Northwestern Pacific Ocean (B), and the area of tropical cyclone formation in the Northeast Pacific Ocean and the Atlantic Ocean (C), frequent occurrence of tropical cyclones can be suppressed.

### REFERENCE SIGNS LIST

1: Water vapor suppression material,
11: Mixture of a plant-based powder and a natural glue of plant origin,
12: Air bubble,
13: Dried surface of a mixture formed into a granular shape,
14: Coating agent composed of a natural glue of plant origin,
2: Airplane,
3: Special ship for raw material plant collection, processing into a water vapor suppression material, and distribution,
4: Evaporation of water vapor,
5: Seaweed or algae,
6: Dried seaweed or algae,
7: Seaweed or algae dried and formed into a powder shape,
8: Natural glue of plant origin,
9: Water surface over which a water vapor suppression material is distributed,
A: Area of tropical cyclone formation in the Indian Ocean,
B: Area of tropical cyclone formation in the Northwestern Pacific Ocean,
C: Area of tropical cyclone formation in the Northeast Pacific Ocean and the Atlantic Ocean

1. A water vapor suppression material comprising grains obtained by granulating a natural glue of plant origin, for being distributed over a water surface to suppress the evaporation of water vapor.

2. A water vapor suppression material comprising grains obtained by forming a mixture of a natural glue of plant origin and a plant-based powder into a granular shape, for being distributed over a water surface to suppress the evaporation of water vapor.

3. The water vapor suppression material according to claim 2, wherein the plant is seaweed or algae.

4. The water vapor suppression material according to claim 1, wherein the grains have enclosed therein air bubbles.

5. The water vapor suppression material according to claim 1, wherein the grains are surface-coated with a natural glue of plant origin that serves as a coating agent.

6. The water vapor suppression material according to claim 1, wherein the water surface over which the material is distributed is an ocean water surface, and excessive evaporation of water vapor from the ocean water surface is suppressed.

7. A method for producing a water vapor suppression material, wherein seaweed or algae is dried, formed into a powder shape, then re-dried, mixed with a natural glue of plant origin that serves as a binder, kneaded to such a viscosity that air bubbles can be contained, and formed into a belt shape; several layers of the belt-shaped mixture are stacked while enclosing air bubbles, granulated into a granular shape, and then dried; and the granules are surface-coated with a natural glue of plant origin that serves as a coating agent and then dried.

8. The water vapor suppression material according to claim 2, wherein the grains have enclosed therein air bubbles.

9. The water vapor suppression material according to claim 3, wherein the grains have enclosed therein air bubbles.

10. The water vapor suppression material according to claim 2, wherein the grains are surface-coated with a natural glue of plant origin that serves as a coating agent.

11. The water vapor suppression material according to claim 3, wherein the grains are surface-coated with a natural glue of plant origin that serves as a coating agent.

12. The water vapor suppression material according to claim 4, wherein the grains are surface-coated with a natural glue of plant origin that serves as a coating agent.

13. The water vapor suppression material according to claim 2, wherein the water surface over which the material is distributed is an ocean water surface, and excessive evaporation of water vapor from the ocean water surface is suppressed.

14. The water vapor suppression material according to claim 3, wherein the water surface over which the material is distributed is an ocean water surface, and excessive evaporation of water vapor from the ocean water surface is suppressed.

15. The water vapor suppression material according to claim 4, wherein the water surface over which the material is distributed is an ocean water surface, and excessive evaporation of water vapor from the ocean water surface is suppressed.

16. The water vapor suppression material according to claim 5, wherein the water surface over which the material is distributed is an ocean water surface, and excessive evaporation of water vapor from the ocean water surface is suppressed.
